(19) United States
(12) Patent Application Publication
(10) Pub. No.: US 2007/0241115 A1
(43) Pub. Date: Oct. 18, 2007

(54) Multi-Chamber System Serving as a Liquid Equalizing Tank, and Use Thereof

(75) Inventors: Markus Baumann, Nurnberg (DE); Manfred Britting, Schnaittach (DE); Thomas Weike, Oppenweiler (DE)

Correspondence Address: LERNER GREENBERG STEMER LLP, P O BOX 2480, HOLLYWOOD, FL, 33022-2480, US

(73) Assignee: SIEMENS AKTIENGESELLSCHAFT

(21) Appl. No.: 11/547,499

(22) PCT Filed: Mar. 18, 2005
(86) PCT No.: PCT/DE05/00518

§ 371 Date: Oct. 13, 2006

(30) Foreign Application Priority Data
Mar. 31, 2004 (DE) 10 2004 016 583.1

(51) Int. Cl. B60P 3/24

(52) U.S. Cl. 220/564; 220/565

(57) ABSTRACT

A multi-chamber system serves as a liquid equalizing tank that is suitable, by way of example, for use in a cooling system. In the novel multi-chamber system, a liquid expansion tank is provided due to the arrangement of the chambers and pipe systems whereby preventing external gases from entering the liquid system and enabling it to also be used in accelerated systems, such as a vehicle since no leveled out liquid columns are used. This makes it possible to provide a system for monitoring a volume of gas in a liquid-filled installation that, in addition to the multi-chamber system, also contains a Buchholz relay in the cooling liquid system. The use of this system for monitoring a volume of gas is thus suitable for means of transportation.

Electrical components, in particular transformers, are protected from thermal overheating during operation by means of liquid cooling circuits such as, for example, oil circuits. The transformer oil expands as a result of being warmed, and is collected above the transformer via an oil line in an oil expansion tank which is also partially filled with transformer oil. A so-called Buchholz relay is often arranged in the oil line between the oil expansion tank and the transformer, the Buchholz relay measuring the gas which forms in the transformer and triggering a shutdown of the transformer if a predefined gas volume is exceeded. A large gas volume is a common indicator of a fault within the transformer. For the operation of an oil-cooled transformer, the German industry standard DIN 42566 prescribes that a warning signal is triggered by means of a Buchholz relay if a predefined gas volume is exceeded within the installation. Here, it is detected within the Buchholz relay as a corresponding expansion tank and gas collecting container, which is connected upstream of an actual liquid expansion tank, whether the predefined gas volume has been reached.

In the known systems, air is also sucked from the environment through a ventilation opening in the oil expansion tank as the transformer oil is cooled, and the moisture in the ambient air is reduced by means of an air dehumidifier. The infiltration of air or moisture into the cooling circuit is to be avoided in any case, since this considerably reduces the dielectric strength of the transformer.

DE 196 36 456 A1 discloses a device for keeping foreign gas out of systems having volumes which change as a function of temperature, in particular electrical transformers, connected to an integrated device for influencing a pressure as a function, or independently, of the temperature of the insulating liquid. The invention described in said document has an expansion tank which is such that a diaphragm is arranged between the insulating liquid and the ambient air or a gas cushion, said diaphragm preventing a direct exchange between the ambient air and the cooling circuit.

GB318397 discloses an expansion tank for transformers in which an elastic diaphragm in the expansion tank separates the liquid surface from a gas cushion and therefore prevents an exchange of air with the ambient air.

A disadvantage of said known prior art is that, in the event of an excessive rise in the gas volume within the transformer, there is no shutdown mechanism, since the above described systems are designed only for a completely liquid-filled cooling circuit.

GB368264 describes an expansion tank for transformers in which a multi-chamber system, in which the chambers are arranged so as to be stepped relative to one another, prevents an infiltration of the ambient air into the cooling circuit. A disadvantage with this is, however, that said system functions only in a static intertial system, since an acceleration of the expansion tank could move the liquid columns relative to one another and an infiltration of ambient air into the cooling circuit would therefore be possible.

An object of the present invention is to avoid the abovementioned disadvantages of the prior art and to provide an expansion tank which can also be operated in a system which is subject to acceleration.

The object is achieved by means of the invention described in claim 1. Here, it is provided according to the invention that in a first chamber, a first pipeline system connects the first chamber to a liquid system, and a second pipeline system connects the first chamber to at least one further, second chamber, the second pipeline system being arranged in the second chamber in such a way that, when liquid is present in the second chamber, the liquid pressure generated as a result is likewise present in the second pipeline system, and the second pipeline system being arranged in the first chamber in such a way that the second pipeline system is likewise completely filled with a liquid, and a hydraulic connection is therefore produced between the liquid system and the second chamber, only when the first chamber is completely filled with a liquid. The infiltration of ambient air or gases into the liquid system via the second chamber is likewise prevented in this case when the first pipeline system is completely filled. The opening of the second pipeline system is advantageously arranged in the upper region of the first chamber.

It is also advantageous for at least one diaphragm in the second chamber to sealingly close off the surface of the liquid from the gas phase in the second chamber. According to a further preferred embodiment of the invention, the first chamber is arranged within the second chamber, the chambers being rotationally symmetrical, and the surface of the liquid in the second chamber being sealingly closed off from the gas phase in the second chamber by means of a rotationally symmetrical diaphragm. Said arrangement of the chambers allows one individual diaphragm, for example in the shape of a ring, to be used. The diaphragm is preferably elastic.

Brackets on the inner wall of the second chamber advantageously fix the diaphragm. Alternatively, guide rails, which provide sealing closure, on the inner wall of the second chamber guide the diaphragm corresponding to the liquid surface in the second chamber. In said arrangement, the mechanical loading of the diaphragm is reduced in comparison to a rigid fixing.

The cross sections and/or the heights of the pipeline systems are preferably designed and configured as a function of the maximum possible liquid pressure in the first chamber. An air dehumidifier reduces the moisture in the gas phase in the second chamber so that the upper side of the diaphragm is not chemically or physically corroded by moisture in the gas phase.

The invention also provides a system for monitoring a gas volume in a liquid-filled installation (9), in particular a transformer, comprising at least one multi-chamber system, a liquid system and a device for monitoring the gas volume, in particular a Buchholz relay, the installation being connected via a liquid system to the device for monitoring the gas volume and to the multi-chamber system. According to one preferred embodiment, the multi-chamber system is arranged downstream of the device for monitoring the gas volume.

The use of the multi-chamber system as an expansion tank for liquid-cooled installations, in particular transformers, in a means of transport is also advantageous. The use of the system for monitoring a gas volume in a means of transport is also advantageous. An approximately leveled-out liquid column is no longer ensured in the expansion tank when the means of transport accelerates, so that, as a result, considerable pressure fluctuations can occur, and ambient air can pass into the liquid cooling system. The multi-chamber system according to the invention offers the advantage that it is also possible to use a liquid system for a transformer in systems which are subject to acceleration such as, for example, a vehicle. The infiltration of air or gases from the outer region of the system is also prevented, even during acceleration.

Further advantageous measures are described in the subclaims; the invention is described in more detail in the following on the basis of exemplary embodiments and the following figures, in which:

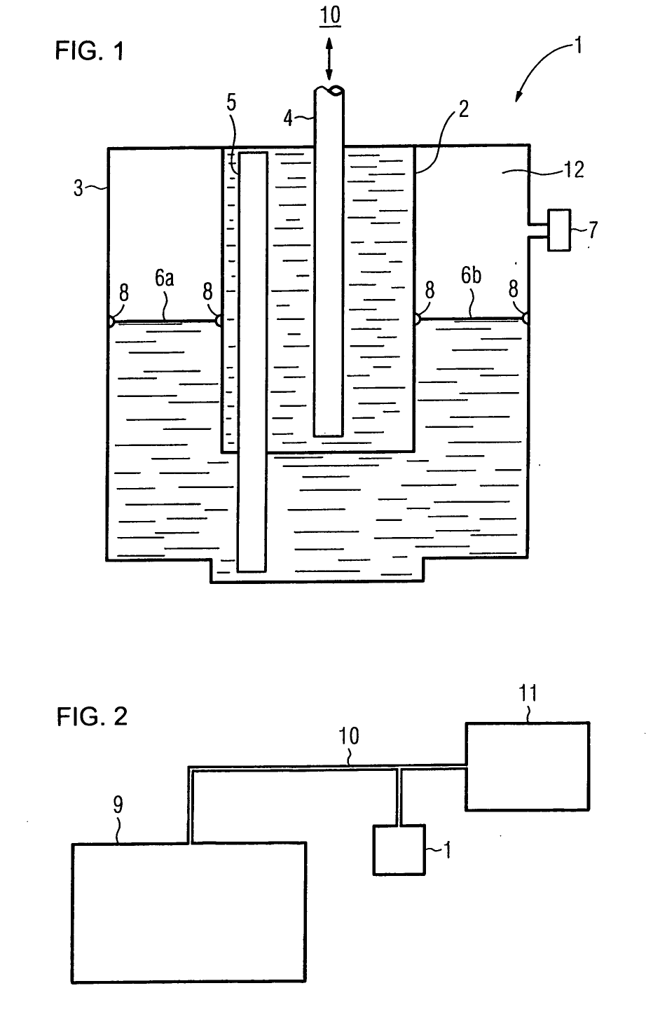

FIG. 1 is a schematic illustration of the multi-chamber system according to the invention;

FIG. 2 is a schematic illustration of the system according to the invention for monitoring a gas volume in a liquid-filled installation.

FIG. 1 illustrates a multi-chamber system 1 according to the invention.

The first chamber 2 is arranged in the second chamber 3 and the two chambers 2, 3 are connected to one another by means of a second pipeline system 5. A first pipeline system 4 is connected to a liquid system 10. The first chamber 2 is completely filled with liquid, preferably with a cooling liquid such as, for example, transformer oil. The second pipeline system 5 is arranged in the first chamber 2 in such a way that liquid can be moved between the first and second chambers 2, 3 only via the upper opening of the second pipeline system 5, the opening being arranged close below the top cover of the first chamber 2. In this case, a hydraulic connection is only produced between the second container 3 and the cooling system via the liquid system 10 when the first chamber 2 is completely filled with a liquid. Said design also prevents air or gases in the second chamber 3 passing into the first chamber 2 via the second pipeline system 5 and subsequently into the liquid system 10 via the first pipeline system 4. The air dehumidifier 7 serves to reduce the degree of humidity in the gas phase above the liquid surface.

According to the invention, at least one diaphragm 6a, 6b is also provided which, in the second chamber 3, tightly and hermetically seals off the liquid from the gas phase. The diaphragm 6a is fixed to the inner wall of the second chamber 3 by means of brackets 8. This prevents an infiltration of air or gases into the multi-chamber system 1 and therefore the liquid system 10 even if the liquid columns in the pipeline systems “break down” as a result of external influences and air or gases can infiltrate the system. In this case, the elastic diaphragm 6a deforms corresponding to the liquid movements in the second chamber 3, and therefore allows an equalization of the liquid within the multi-chamber system 1 and therefore the liquid system 10 without it being possible for air or gases to pass in. Said multi-chamber system 1 according to the invention also prevents air or gases from the gas phase of the second chamber 3 from diffusing into the liquid of the second chamber 3.

The air dehumidifier 7 serves to reduce the degree of humidity of the gas phase above the liquid surface or above the diaphragm surface 6a.

FIG. 2 is a schematic illustration of the system according to the invention for monitoring a gas volume in a liquid-filled installation 9, for example a transformer. The gases produced in the liquid-filled installation 9 are conveyed onward in a liquid system 10 to a Buchholz relay 11. The gas volume produced is monitored in the Buchholz relay. The multi-chamber system 1 is also coupled as an expansion tank to the liquid system. The position of the multi-chamber system 1 relative to the transformer 9 or relative to the Buchholz relay 11 is arbitrary, since the pressure equalization in the second chamber 3 (not illustrated) takes place with the liquid system 10 as a result of a hydraulic connection. The system is therefore also suitable for use in systems which are subject to acceleration.

Reference symbols

| 1. | Multi-chamber system |
|---|---|
| 2. | First chamber |
| 3. | Second chamber |
| 4 | First pipeline system |
| 5. | Second pipeline system |
| 6.a., 6.b. | Diaphragm |
| 7. | Air dehumidifier |
| 8. | Diaphragm bracket |
| 9. | Liquid-filled installation |
| 10. | Liquid system |
| 11. | Device for monitoring a gas volume |
| 12. | Gas phase in the second chamber |

1-12. (canceled)

13. A multi-chamber system forming a liquid expansion tank, comprising:
a first pipeline system disposed in and connecting a first chamber to a liquid system;
a second pipeline system connecting said first chamber to at least one second chamber;
wherein said second pipeline system is arranged in said second chamber such that, when liquid is present in said second chamber, a liquid pressure thus generated is also present in said second pipeline system; and
wherein said second pipeline system is arranged in said first chamber such that said second pipeline system is completely filled with a liquid, and a hydraulic connection is produced between said liquid system and said second chamber, only when said first chamber is substantially completely filled with a liquid.

14. The multi-chamber system according to claim 13, wherein said second pipeline system has an opening disposed in an upper region of said first chamber.

15. The multi-chamber system according to claim 13, which comprises at least one diaphragm disposed in said second chamber for sealingly closing off a surface of the liquid from a gas phase in said second chamber.

16. The multi-chamber system according to claim 15, wherein said first chamber is disposed within said second chamber, said first and second chambers being rotationally symmetrical, and the surface of the liquid in said second chamber is sealingly closed off from the gas phase in the second chamber by way of a rotationally symmetrical diaphragm.

17. The multi-chamber system according to claim 15, wherein said diaphragm is an elastic diaphragm.

18. The multi-chamber system according to claim 15, which comprises brackets on an inner wall of said second chamber fixing said diaphragm.

19. The multi-chamber system according to claim 15, which comprises guide rails, providing sealing closure, on an inner wall of said second chamber for guiding said diaphragm corresponding to the liquid surface in said second chamber.

20. The multi-chamber system according to claim 13, wherein at least one parameter of said pipeline systems, the parameters being selected from the group consisting of cross sections and height levels of said pipeline systems, is configured as a function of a maximum possible liquid pressure in said first chamber.

21. The multi-chamber system according to claim 13, which comprises an air dehumidifier disposed to reduce a moisture in a gas phase in said second chamber.

22. A system for monitoring a gas volume in a liquid-filled installation, the system comprising:
at least one multi-chamber system according to claim 13;
a liquid system communicating with said first pipeline system;
a monitoring device for monitoring a gas volume;
wherein the liquid-filled installation is connected via a liquid system to said monitoring device and to the at least one multi-chamber system.

23. The system according to claim 22, wherein the liquid-filled installation is a transformer.

24. The system according to claim 22, wherein said monitoring device is a Buchholz relay.

25. The system according to claim 22, wherein the multi-chamber system is disposed downstream of said monitoring device or monitoring the gas volume.

26. In combination with a transportation device, the multi-chamber system according to claim 13 configured as an expansion tank for a liquid-cooled installation in the transportation device.

27. The combination according to claim 26, wherein the liquid-cooled installation is a transformer.

28. In combination with a transportation device, a system for monitoring a gas volume in a liquid-filled installation of the transportation device, the system comprising:
at least one multi-chamber system according to claim 13;
a liquid system communicating with said first pipeline system; and
a monitoring device for monitoring a gas volume;
wherein the liquid-filled installation is connected via a liquid system to said monitoring device and to the at least one multi-chamber system.
